(19) United States
(12) Patent Application Publication
(10) Pub. No.: US 2001/0054990 A1
(43) Pub. Date: Dec. 27, 2001

(54) Image display system

(76) Inventors: Tomoyuki Nakamura, Hachioji-shi (JP); Akihiro Kubota, Kokubunji-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/891,175

(22) Filed: Jun. 26, 2001

(30) Foreign Application Priority Data
Jun. 26, 2000 (JP) 2000-191471

(51) Int. Cl. G09G 3/00

(52) U.S. Cl. 345/32

(57) ABSTRACT

An image display system comprising signal processing means for separating an input video signal into video signals for a plurality of basic colors in a color image, a plurality of single color projection units provided in accordance with the respective basic colors, each of the single color projection units including an image display device, a drive circuit for driving the image display device, illuminating light supplying means for supplying illuminating light to the image display device, and a single lens for projecting an image from the image display device illuminated with the illuminating light, a screen on which a plurality of images projected from the single color projection units are combined and displayed, and correcting means for correcting each video signal separated by the signal processing means and supplying the corrected video signal to each single color projection unit.

### CROSS-REFERENCE TO RELATED APPLICATIONS

This application is based upon and claims the benefit of priority from the prior Japanese Patent Application No. 2000-191471, filed Jun. 26, 2000, the entire contents of which are incorporated herein by reference.

### BACKGROUND OF THE INVENTION

The present invention relates to an image display system, and more particularly to an image display system for projecting a color image on a screen to perform display.

As an image display system for projecting a color image on a screen, there is known a 3-chip system by which images of R, G and B are projected from three LCD panels to be combined into one image on a screen.

In the image display system adopting the 3-chip system, as disclosed in, for example, Jpn. Pat. Appln. KOKAI Publication No. 7-199068, it is often the case that a projection optical system common to three colors is used as a projection optical system for projecting an image on a screen. In this case, aberrations (chromatic aberrations, for example) generated on respective spherical surfaces are canceled out by combining a plurality of spherical surfaces by using a plurality of lenses.

However, if the number of lenses is increased in order to suppress the aberrations, the design difficulty therefore also increases. It is, therefore, difficult to keep the price low. Further, since the respective lenses are designed so as to be adapted to three primary colors, it is difficult to adapt the lenses to all the primary colors when a number of the primary colors is increased to realize multiple primary colors. Furthermore, when a number of the primary colors is increased, a prism for synthesization must be newly produced.

On the other hand, for example, Jpn. Pat. Appln. KOKAI Publication No. 5-328370 proposes a system in which respective images of R, G and B are projected on a screen, the projected images are imaged by a digital camera and the like, and geometric distortion, convergence and others are automatically adjusted based on a result of imaging. However, when the number of primary colors is increased, an adjustment method must be considered each time, and hence adjustment is not easy.

As described above, the conventional image display system has problems that the price of an optical system for projection is high or that countermeasures for multiple primary colors are difficult.

### BRIEF SUMMARY OF THE INVENTION

In view of the above-described problems, it is an object of the present invention to provide an image display system in which an optical system for projection can be inexpensively constituted and countermeasures for multiple primary colors can be facilitated.

According to the present invention, there is provided an image display system comprising: signal processing means for separating an input video signal into video signals for a plurality of basic colors in a color image; a plurality of single color projection units provided in accordance with the respective basic colors, each of the single color projection units having: an image display device; a drive circuit for driving the image display device; illuminating light supplying means for supplying illuminating light to the image display device; and a single lens for projecting an image from the image display device illuminated with the illuminating light, a screen on which a plurality of images projected from the single color projection units are synthesized and displayed; and correcting means for correcting respective video signals separated by the signal processing means and supplying the respective corrected video signals to the respective single color projection units.

It is preferable that the single color projection unit is replaceable.

It is preferable that that the illuminating light supplying means includes a light source for generating the illuminating light.

It is preferable that the illuminating light supplying means includes color separating means for separating the light ray for the basic color from external light ray supplied from the outside of the single color projection units.

It is preferable that the illuminating light supplying means further includes attenuating means for attenuating the light ray from the color separating means.

It is preferable that the present invention further comprises attenuation quantity controlling means for controlling a light attenuation quantity in the attenuating means.

It is preferable that the single color projection units are arranged on the slant with respect to the screen in such a manner that display areas of images from the single color projection units projected on the screen overlap each other.

It is preferable that the single color projection units are accommodated in a case which can arrange the single color projection units on the slant with respect to the screen.

It is preferable that the illuminating light supplying means includes color separating means for separating the light ray for the basic color from external light ray supplied from the outside of the single color projection unit and the image display system further comprises light reflecting means for supplying the external light ray to the color separating means of each single color projection unit.

It is preferable that an angle of inclination of the single color projection unit with respect to the screen can be adjusted.

It is preferable that the image display system further comprises imaging means for imaging reference images projected on the screen from the single color projection units and the correcting means corrects the video signals based on information of the reference images obtained by the imaging means.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a structural example of a primary part of an image display system according to a first embodiment of the present invention;

FIG. 2 is a view showing a color reproduction range when the number of primary colors is increased in the image display system according the embodiment of the present invention;

FIG. 3 is a block diagram showing a structural example of a primary part of an image display system according to a second embodiment of the present invention;

FIG. 4 is a view showing a modification of a single color projection unit in the image display system according to the second embodiment of the present invention;

FIG. 5 is a view showing a structural example of a primary part of an example of an image display system according to a third embodiment of the present invention;

FIG. 6A is a view showing a display range when the single color projection units are arranged in parallel, and FIG. 6B is a view showing a display range when the single color projection units are obliquely arranged; and

FIGS. 7A, 7B and 7C are views showing other examples of the image display system according to the third embodiment of the present invention.

### DETAILED DESCRIPTION OF THE INVENTION

Embodiments according to the present invention will now be described with reference to the accompanying drawings.

(Embodiment 1)

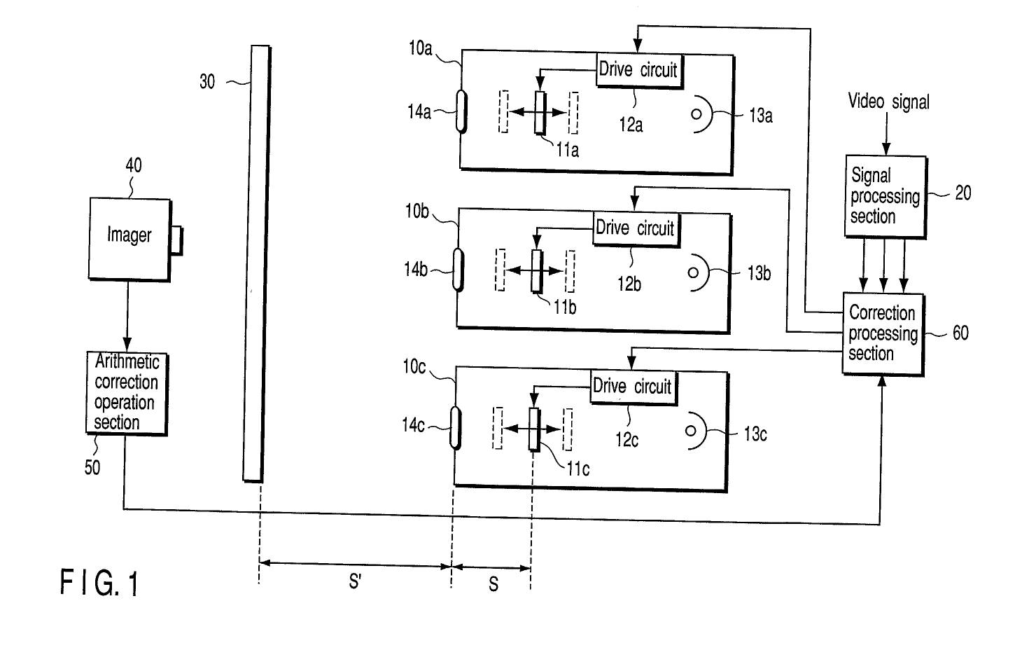

FIG. 1 is a block diagram showing a structural example of a primary part of an image display system according to a first embodiment of the present invention.

Respective single color projection units 10a, 10b and 10c are provided in accordance with three primary colors used for synthesizing a color image. For example, the single color projection unit 10a corresponds to a red (R) image; the single color projection unit 10b, a green (G) image; and the single color projection unit 10c, a blue (B) image.

Image display devices 11a, 11b and 11c using, for example, LCDs are provided in the single color projection units 10a, 10b and 10c. The image display devices 11a, 11b and 11c are driven by drive circuits 12a, 12b and 12c, respectively. The image display devices 11a, 11b and 11c are obtained by arranging a plurality of pixels in a matrix form. A desired image can be obtained by controlling the transmittance of each pixel by signals fed from the drive circuits 12a, 12b and 12c. The image display devices 11a, 11b and 11c can be moved in a forwards and backwards direction as shown in the drawing.

Light sources 13a, 13b and 13c are provided at the rear of the image display devices 11a, 11b and 11c, and illuminating light is supplied to the image display devices 11a, 11b and 11c. It is preferable that the light rays from the respective light sources 13a, 13b and 13c correspond to colors (R, G and B) of images generated by the respective single color projection units 10a, 10b and 10c. However, since it is good enough that the colors of the images finally generated by the respective single color projection units correspond to the three primary colors, the respective light sources including components of the primary colors can suffice. The light sources may be white light sources or light sources having only components in a predetermined wavelength band. In addition, when images from the respective single color projection units are combined on a screen, it is preferable that the light sources are adjusted so that the respective colors are balanced.

Single lenses 14a, 14b and 14c for image formation are provided in front of the image display devices 11a, 11b and 11c. Respective images generated by the image display devices 11a, 11b and 11c are displayed on the screen by the single lenses 14a, 14b and 14c. The single lenses 14a, 14b and 14c are exclusively used for respective primary colors (R, G and B) and constituted by each single lens.

Incidentally, it is preferable that the single color projection units 10a and 10c on the outer side are arranged so as to be inclined toward the inner side in such a manner that the display areas of respective images projected on the screen from the single color projection units overlap each other.

The video signals supplied to the respective single color projection units 10a, 10b and 10c are obtained by separating the primary video signals supplied from the outside by a signal processing section 20.

A screen 30 is provided in front of the single color projection units 10a, 10b and 10c. Images of respective primary colors projected from the single color projection units are combined on the screen, thereby displaying a full-color image. Any type of screen, for example, a transmission type or reflection type screen can be used as the screen 30.

An imager 40 using, for example, a digital camera is arranged at the rear of the screen 30. The imager 40 is used for pre-adjustment of the image projected on the screen 30. Respective images for adjustment (reference images) projected on the screen 30 from the single color projection units 10a, 10b and 10c are imaged by the imager 40.

Image information of images for adjustment obtained by the imager 40 is supplied to an arithmetic correction operation section 50. The arithmetic correction operation section 50 carries out the arithmetic operation for correcting defects of images such as geometric distortion or displacement.

An arithmetic operation result (correction data) obtained in the arithmetic correction operation section 50 is supplied to a correction processing section 60. The correction processing section 60 carries out correction processing with respect to each video signal separated by the signal processing section 20 based on the correction data.

Here, a description will now be given as to the positional relationship between the image display devices 11a to 11c, the single lenses 14a to 14c and the screen 30.

Assuming that a focal distance of the single lenses 14a to 14c is f, a distance between the single lenses 14a to 14c and the image display devices 11a to 11c is s, and a distance between the single lenses 14a to 14c and the screen 30 is s′, the following expression can be obtained:

1/s′=1/s+1/f

A magnification Y can be expressed as follows:

Y=s′/s

Usually, the focal distance f of the single lenses 14a to 14c is fixed. Therefore, if the distance s′ between the screen 30 and the single lenses 14a to 14c is determined, the distance s between the single lenses 14a to 14c and the image display devices 11a to 11c and the magnification Y are determined. That is, an image size on the screen 30 is determined.

On the grounds mentioned above, the image display devices 11a to 11c can move in the forwards and backwards direction along an optical axis of the single lenses 14a to 14c as described above. Further, the positions of the image display devices 11a to 11c can be changed in accordance with the distance between the screen 30 and the single color projection units 10a to 10c and an image size which is desired to be displayed.

Furthermore, in order to enlarge an image, the distance s between the single lenses 14a to 14c and the image display devices 11a to 11c is set shorter than the distance s′ between the single lenses 14a to 14c and the screen 30. Therefore, a lens having a negative power such as a concave lens is required.

The operation of this embodiment will now be described.

A video signal of an image for adjustment is inputted to the signal processing section 20. The signal processing section 20 separates the video signal of an image for adjustment into video signals corresponding to the respective primary colors. The respective separated video signals are supplied to drive circuits 12a, 12b and 12c in the single color projector units 10a, 10b and 10c via correction processing section 60. Images corresponding to the respective primary colors are displayed on the respective image display devices 11a, 11b and 11c based on the signals from the drive circuits. The image display devices 11a, 11b and 11c are illuminated with the illuminating light rays from the light sources 13a, 13b and 13c. Image light rays from the image display devices 11a, 11b and 11c are incident upon the single lenses 14a, 14b and 14c, and images enlarged by the respective single lenses are displayed on the screen 30.

A user adjusts the arrangement of the respective single color projection units while watching the images projected on the screen 30 in such a manner that the images from the respective single color projection units 10a, 10b and 10c overlap each other on the screen 30 as much as possible.

After the arrangement of the respective single color projection units is determined, the respective images for adjustment projected on the screen 30 from the single color projection units 10a, 10b and 10c are imaged by the imager 40 in accordance with each image. The image data of each image for adjustment which has been imaged is supplied to the arithmetic correction operation section 50, and the arithmetic operation processing is carried out in order to correct defects of the image such as geometric distortion or displacement. The correction data obtained by the arithmetic operation processing is supplied to the correction processing section 60.

After conducting the adjustment operation (correction operation) as described above, a video signal of an image which is desired to be actually displayed is inputted to the signal processing section 20. The signal processing section 20 separates the inputted video signal into a video signal for each primary color and transmits a resulting signal to the correction processing section 60. The correction processing section 60 applies the correction processing to the video signal separated by the signal processing section 20 based on the correction data obtained in advance. Each video signal subjected to the correction processing is supplied to the drive circuits 12a, 12b and 12c in the respective single color projection units 10a, 10b and 10c. Images subjected to the correction processing are displayed on the image display devices 11a, 11b and 11c by using the signals from the respective drive circuits. The images displayed on the image display devices 11a, 11b and 11c are illuminated with the illuminating light rays from the light sources 13a, 13b and 13c. The image light rays of the images illuminated with the illuminating light rays are incident upon the single lenses 14a, 14b and 14c. The images enlarged by the respective single lenses are projected on the screen 30, and a color image in which the respective primary colors are combined is displayed on the screen 30.

As described above, in this embodiment, the single lens for image formation is used for the projection optical system of each single color projection unit. When the image is projected on the screen by using only the single lens, a distortion is usually caused in the projected image by aberrations of the lens. In this embodiment, by imaging the image for adjustment projected on the screen through the single lens and correcting the image which is desired to be actually displayed based on the image information of the image for adjustment which has been imaged, the distortion of the image generated by the aberration of the lens is canceled out. Therefore, an expensive lens does not have to be used for the projection optical system as in the prior art, and an image superior in display quality can be obtained even if the projection optical system is configured by an inexpensive single lens.

Incidentally, although description has been given as to the example in which the three single color projection units are used in accordance with the three primary colors of R, G and B in the above-described embodiment, the number of primary colors may be increased and the single color projection units whose number corresponds to that of the primary colors may be used.

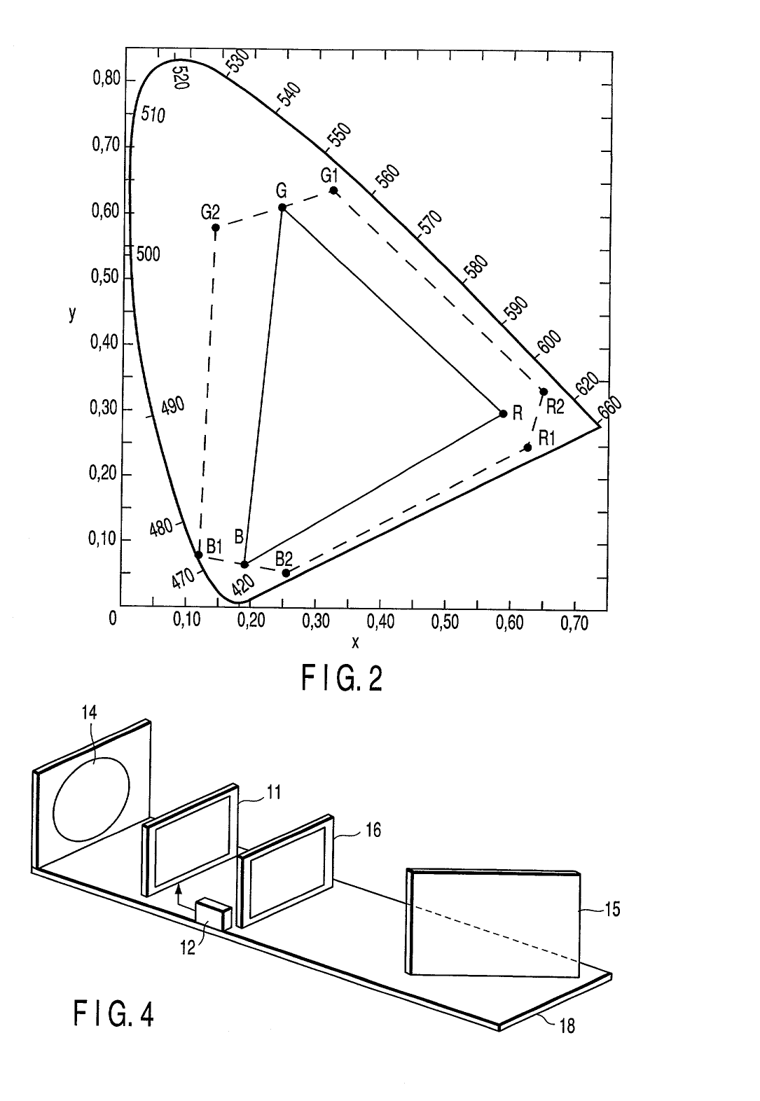

Color reproduction with an increased number of primary colors will now be described with reference to a chromaticity diagram of the CIE standard calorimetric system shown in FIG. 2. In general, a CRT or an LCD displays a color image by using the three primary colors of R, G and B, and a range of colors which can be displayed is on the inner side of a solid line (inner side of a triangle of R, G and B) shown in FIG. 2. When the number of primary colors is increased and six primary colors of R₁, R₂, G₁, G₂, B₁ and B₂ are used, a range of the colors which can be displayed is on the inner side of a broken line (inner side of a hexagon of R₁, R₂, G₁, G₂, B₁ and B₂). As described above, since the range of color reproduction can be enlarged by increasing the number of primary colors, colors falling in a range which cannot be displayed by using only the three primary colors of R, G and B can now be displayed, thereby enabling faithful color reproduction.

In this embodiment, the projection optical system which is common to the respective colors is not used as in the prior art, but an exclusive single lens is used in accordance with each single color projection unit. Therefore, when increasing the number of primary colors, the single color projection units for the primary colors which should be used can be readily produced, thereby facilitating an increase in the number of primary colors.

(Embodiment 2)

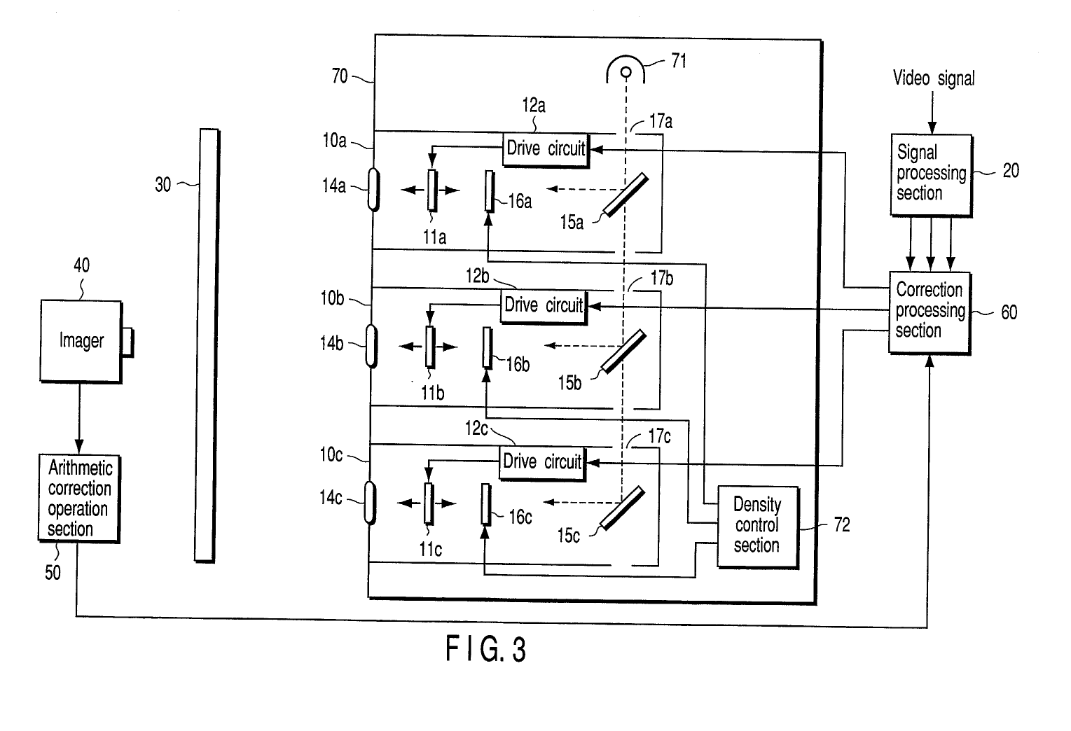

FIG. 3 is a block diagram showing a structural example of a primary part of an image display system according to a second embodiment of the present invention. It is to be noted that the basic structure of the entire system is similar to that of the first embodiment illustrated in FIG. 1 and hence like reference numerals denote like constituent parts, thereby omitting a detailed explanation.

As shown in FIG. 3, the single color projection units 10a, 10b and 10c are accommodated in a projector case 70, and they can be replaced in accordance with each unit.

Comparing the structure of the single projection units 10a, 10b and 10c with the structure of the first embodiment illustrated in FIG. 1, the image display devices 11a, 11b and 11c, the drive circuits 12a, 12b and 12c, and the single lenses for image formation 14a, 14b and 14c basically remain unchanged, but the following structure is different from the first embodiment.

In this embodiment, the respective single color projection units 10a, 10b and 10c are not provided with the light sources, but include color separation portions 15a, 15b and 15c which have function to select the necessary color components from a white light source 71 provided in the projector case 70 and leading these components to the image display devices 11a, 11b and 11c. For example, a dichroic mirror can be used for each of the color separation portions 15a, 15b and 15c.

Moreover, since the intensities of the respective primary color components separated by the color separation portions 15a, 15b and 15c are not necessarily balanced between the primary colors, variable ND filters 16a, 16b and 16c for controlling an attenuation quantity of a light ray are provided in order to achieve the balance between the primary colors. For example, an LCD can be used for this variable ND filter.

In addition, in order that the color separation portions 15a, 15b and 15c can be irradiated with the light from the white light source 71, light incoming portions and light outgoing portions are window portions 17a, 17b and 17c in parts through which the light from the white light source is transmitted. These window portions may have an opening structure or a door structure which can be opened and closed. Additionally, as shown in FIG. 4, it is possible to adopt a structure that respective constituent elements such as the image display device 11, the drive circuit 12, the single lens 14, the color separation portion 15 and the variable ND filter 16 arranged on a plate-like member 18 are exposed without providing a cover on the entire structure. In this case, ventilation is excellent and cooling can be facilitated.

Further, the variable ND filters 16a, 16b and 16c are controlled by a density control section 72 provided in the projector case 70. The density control section 72 can change the density of the variable ND filters 16a, 16b and 16c in accordance with the intensity distribution of a wavelength of the white light source 71, the type of primary colors to be used, brightness balance between the primary colors, etc.

Meanwhile, if the ND filter can be easily replaced with one which can balance the brightness between the respective single color projector units, the density of the ND filter does not necessarily have to be variable. Furthermore, if the wavelength distribution of the white light source 71 is balanced between the primary colors, the variable ND filters 16a to 16c are no longer necessary. Moreover, in case of performing the balance adjustment of the brightness by using the image display devices 11a to 11c, the variable ND filters 16a to 16c are not necessary.

As described above, in this embodiment, the advantages described in connection with the first embodiment can be obtained, and the light source can be shared between the respective single color projector units, which results in a reduction in the number of light sources and realization of power saving.

Incidentally, although the signal processing section 20 and the correction processing section 50 are provided outside the projector case 70 in the example shown in FIG. 3, they may be provided in the projector case 70. When these portions are accommodated in the projector case 70, portage can be facilitated.

Moreover, a cooling device such as a fan may be provided in the projector case 70 to cool down the white light source 71. An optical system which can reduce irregularities of the light rays from the white light source 71 may be arranged between the white light source and the single color projection units. In this case, irregularities of the images displayed on the screen can be decreased.

(Embodiment 3)

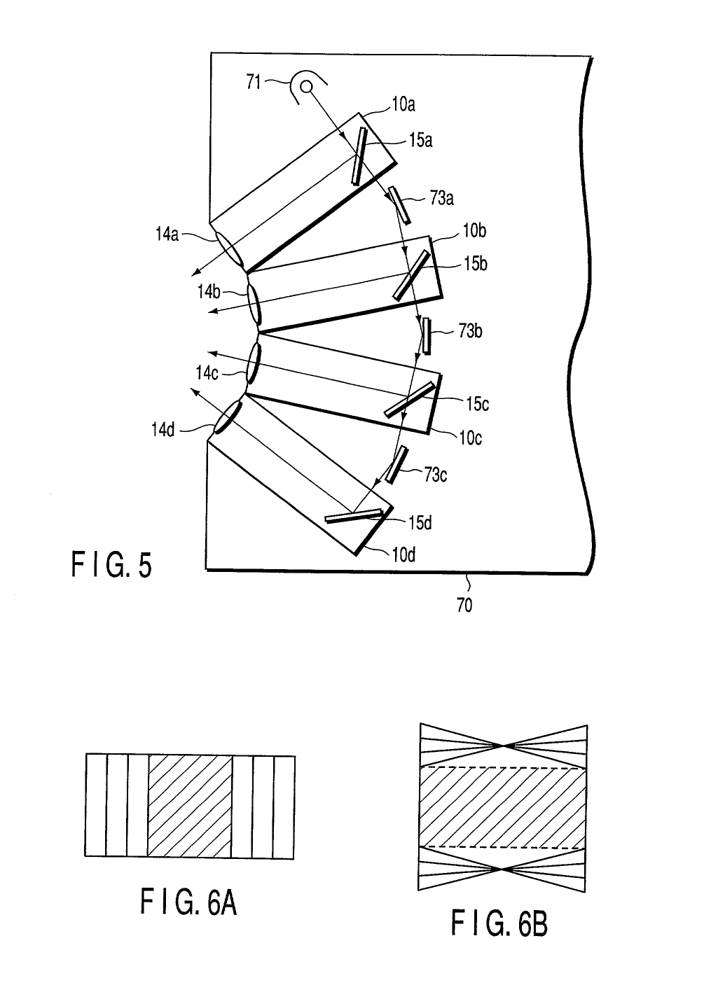

FIG. 5 is a view showing a structural example of a primary part of an image display system according to a third embodiment of the present invention.

The basic structure of the entire system is similar to that of the second embodiment. In this embodiment, the single color projection units 10a to 10d (in this embodiment, an example of a four-primary-color structure is given) in the projector case 70 can be attached on the slant. That is, the single color projection units are arranged so as to be inclined with respect to the screen in such a manner that the display ranges of respective images projected on the screen can overlap each other. Further, mirrors 73a to 73c as light reflecting means are arranged between the single color projection units 10a to 10d to reflect the light rays from the white light source 71 by the mirrors 73a to 73c so that the light rays from the white light source 71 can be appropriately led to the color separation portions 15a to 15d in the single color projection units 10a to 10d.

When the single color projection units are aligned in parallel, the projection ranges of the respective images projected on the screen from the projection units do not completely overlap each other because each single color projection unit itself has a certain size. Therefore, as shown in FIG. 6A, only an area in which all the images overlap each other on the screen (area indicated by oblique lines) becomes an effective display range, thereby narrowing the area in which images can be displayed.

As a countermeasure, in this embodiment, the single color projection units are arranged on a slant in order to enlarge the effective image display range. When the single color projection units are arranged on a slant, the image display area is distorted in the trapezoidal shape as shown in FIG. 6B, but this distortion can be eliminated by effecting the correction processing such as described in connection with the first embodiment.

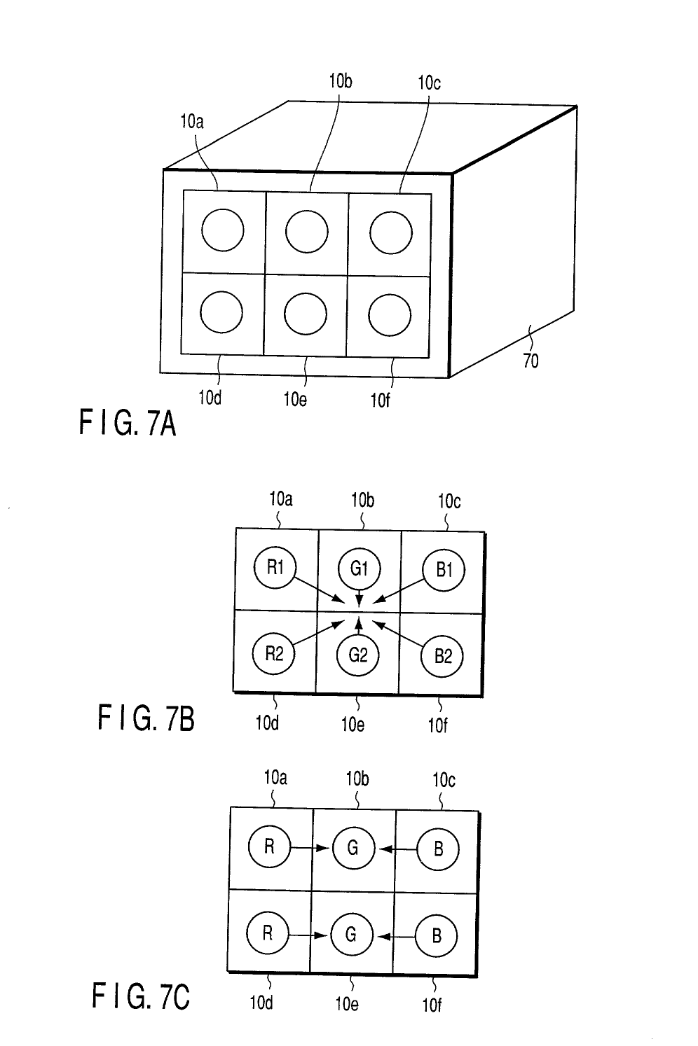

FIGS. 7A, 7B and 7C show examples in which the number of single color projection units is further increased.

As shown in FIG. 7A, six single color projection units 10a to 10f are accommodated in the projector case 70.

In an example illustrated in FIG. 7B, the single color projection units for six primary colors of R₁, R₂, G₁, G₂, B₁ and B₂ are used to synthesize one color image on the screen based on images from the single color projection units 10a to 10f. In this case, the single color projection units 10a to 10f are arranged so as to be inclined toward the central portion as shown in the drawing.

Furthermore, besides the above-described use, a plurality of images can be superimposed on the screen to synthesize one image, and a plurality of such synthesized images can then be coupled with each other to obtain one large image as a whole. In the example shown in FIG. 7C, one image in the upper half part is synthesized by using the three single color projection units 10a, 10b and 10c on the upper side, and one image in the lower half part is then synthesized by using the three single color projection units 10d, 10e and 10f on the lower side. The obtained images are coupled on the screen, thereby displaying one image as a whole. In this case, the single color projection units 10a and 10c on the right and left sides in the upper part are arranged so as to be inclined toward the central single color projection unit 10b, and the single color projection units 10d and 10f on the right and left sides in the lower part are arranged so as to be inclined toward the central single color projection unit 10e.

As described above, different applications are enabled with one projector case by replacing the single color projection units in this example, thereby obtaining an apparatus with a high degree of freedom. Incidentally, since the direction or angle of inclination of each single color projection unit differs depending on use in FIG. 7B and FIG. 7C, it is preferable to provide each single color projection unit with a function for enabling adjustment of the direction or angle of inclination.

In this embodiment, description has been mainly given as to the basic structure such as explained in connection with the second embodiment, i.e., the example of the structure in which the light rays supplied from the outside of the single color projection units are separated by the color separation portions and the separated light rays are supplied to the respective image display devices. However, the technique described in this embodiment can be used in the basic structure explained in connection with the first embodiment, i.e., the structure in which the light sources are included in the respective single color projection units.

As mentioned above, according to the present invention, by correcting the distortion of images generated by aberrations of the lens and the like, high grade images can be obtained even if the projection optical system is constituted by the single lenses, and the projection optical system can be inexpensively structured. Moreover, the structure using the single lenses is adopted which facilitates the countermeasures for an increase in the number of primary colors.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image display system comprising:
signal processing means for separating an input video signal into video signals for a plurality of basic colors in a color image;
a plurality of single color projection units provided in accordance with said respective basic colors;
each of said single color projection units including:
an image display device;
a drive circuit for driving said image display device;
illuminating light supplying means for supplying illuminating light to said image display device; and
a single lens for projecting an image from said image display device illuminated with said illuminating light,
a screen on which a plurality of images projected from said single color projection units are combined and displayed; and
correcting means for correcting each video signal separated by said signal processing means and supplying said corrected video signal to each single color projection unit.

2. The image display system according to claim 1, wherein said single color projection unit is replaceable.

3. The image display system according to claim 1, wherein said illuminating light supplying means includes a light source for generating said illuminating light.

4. The image display system according to claim 1, wherein said illuminating light supplying means includes color separating means for separating light ray of said basic color from an external light ray supplied from the outside of said single color projection units.

5. The image display system according to claim 4, wherein said illuminating light supplying means further includes attenuating means for attenuating light ray from said color separating means.

6. The image display system according to claim 5, further comprising attenuation quantity controlling means for controlling a light attenuation quantity in said attenuating means.

7. The image display system according to claim 1, wherein said single color projection units are arranged so as to be inclined with respect to said screen in such a manner that display areas of images projected on said screen from said single color projection units overlap each other.

8. The image display system according to claim 7, wherein said single color projection units are accommodated in a case in which said single color projection units can be arranged so as to be inclined with respect to said screen.

9. The image display system according to claim 7, wherein said illuminating light supplying means includes color separating means for separating light ray of said basic color from an external light ray supplied from the outside of said single color projection units,
said image display system further comprising light reflecting means for supplying said external light ray to said color separating means of said each single color projection units.

10. The image display system according to claim 7, wherein an angle of inclination of said single color projection units with respect to said screen is adjustable.

11. The image display system according to claim 1, further comprising imaging means for imaging reference images projected on said screen from said single color projection units,
said correcting means correcting said video signals based on information of said reference images obtained by said imaging means.
